(19) United States
(12) Patent Application Publication
(10) Pub. No.: US 2010/0245394 A1
(43) Pub. Date: Sep. 30, 2010

(54) IMAGE PROCESSING APPARATUS, IMAGE PROCESSING METHOD, AND PROGRAM

(76) Inventor: Jun Yokono, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/726,290

(22) Filed: Mar. 17, 2010

(30) Foreign Application Priority Data
Mar. 25, 2009 (JP) P2009-073141

(51) Int. Cl. G09G 5/00

(52) U.S. Cl. 345/660

(57) ABSTRACT

An image processing apparatus detects a representative frame of a moving image. The image processing apparatus includes a holding section configured to hold the moving image which is inputted, a detecting section configured to detect a peak of zooming that occurs in the inputted moving image, and an extracting section configured to extract the representative frame corresponding to the detected peak from a plurality of frames constituting the held moving image.

### BACKGROUND OF THE INVENTION

1. Field of the Invention

The present invention relates to an image processing apparatus, an image processing method, and a program, especially relates to an image processing apparatus, an image processing method, and a program suitable for automatically detecting a noteworthy frame among a plurality of frames constituting a moving image and automatically detecting a noteworthy object in a moving image.

2. Description of the Related Art

There is a technique called digest reproduction which enables a viewer to grasp an outline of a moving image by watching and listening to a part of the moving image without watching and listening to all of the moving image. In the digest reproduction, scenes that seem important are detected from the entire moving image, and only the scenes that seem important are reproduced sequentially.

As a method for detecting scenes that seem important from the entire moving image, there are a method which detects a so-called scene change and detects a frame after the scene change as an important scene, and a method which highlights a moving image sequence (frame) detected by a time-series learning apparatus using HMM (hidden Markov model), in other words which detects the moving image sequence as an important scene (for example, refer to Japanese Unexamined Patent Application Publication No. 2008-21225).

Further, for a moving image in which a TV program of a sports game is recorded, there is a method which detects a frame played in slow motion, a replayed frame, and the like as an important scene.

### SUMMARY OF THE INVENTION

However, in the method which detects an important scene on the basis of a scene change, for example, when an important subject is slowly zoomed in on, it is difficult to detect such a scene as an important scene.

Any of the methods described above is effective when applying to a moving image created by a professional of video shooting and editing, for example, such as a TV program. However, for example, these methods are not necessarily effective for a moving image shot by an ordinary user of a home video camera, and an important scene may be difficult to be detected.

It is desirable to detect an important scene from a moving image shot by an ordinary user of a home video camera.

An image processing apparatus according to an embodiment of the present invention includes, in the image processing apparatus which detects a representative frame of a moving image, holding means configured to hold the moving image which is inputted, detecting means configured to detect a peak of zooming that occurs in the inputted moving image, and an extracting means configured to extract the representative frame corresponding to the detected peak from a plurality of frames constituting the held moving image.

The image processing apparatus according to an embodiment of the present invention can further include calculating means configured to calculate an optical flow of the inputted moving image and calculate a scale parameter indicating a zoom state of each frame on the basis of the calculated optical flow, wherein the detecting means can detect an extreme value of the scale parameter as a peak of the zoom of the inputted moving image.

The extracting means can extract the representative frame corresponding to the detected peak from a plurality of frames constituting the held moving image, and output the representative frame as a digest image.

The extracting means can extract the representative frame corresponding to the detected peak and a predetermined number of frames before and after the representative frame from a plurality of frames constituting the held moving image, and output the representative frame and the predetermined number of frames as training image candidates in object recognition.

An image processing method according to an embodiment of the present invention includes the steps of, in the image processing method which detects a representative frame of a moving image, holding the moving image which is inputted, detecting a peak of zooming that occurs in the inputted moving image, and extracting the representative frame corresponding to the detected peak from a plurality of frames constituting the held moving image.

A program according to an embodiment of the present invention is a control program of an image processing apparatus for detecting a representative frame of a moving image, and the program causes a computer of an image processing apparatus to execute processing including the steps of holding the moving image which is inputted, detecting a peak of zooming that occurs in the inputted moving image, and extracting the representative frame corresponding to the detected peak from a plurality of frames constituting the held moving image.

In an embodiment of the present invention, an inputted moving image is held, and a peak of zooming that occurs in the inputted moving image is detected. Further, a representative frame corresponding to the detected peak is extracted from a plurality of frames constituting the held moving image.

According to an embodiment of the present invention, a scene that seems important can be detected from a moving image.

### BRIEF DESCRIPTION OF THE DRAWINGS

FIG. 1 is a view for explaining a principle according to an embodiment of the present invention;

FIG. 2 is a block diagram illustrating a configuration example of an image processing apparatus to which an embodiment of the present invention is applied;

FIG. 3 is a view for explaining an optical flow;

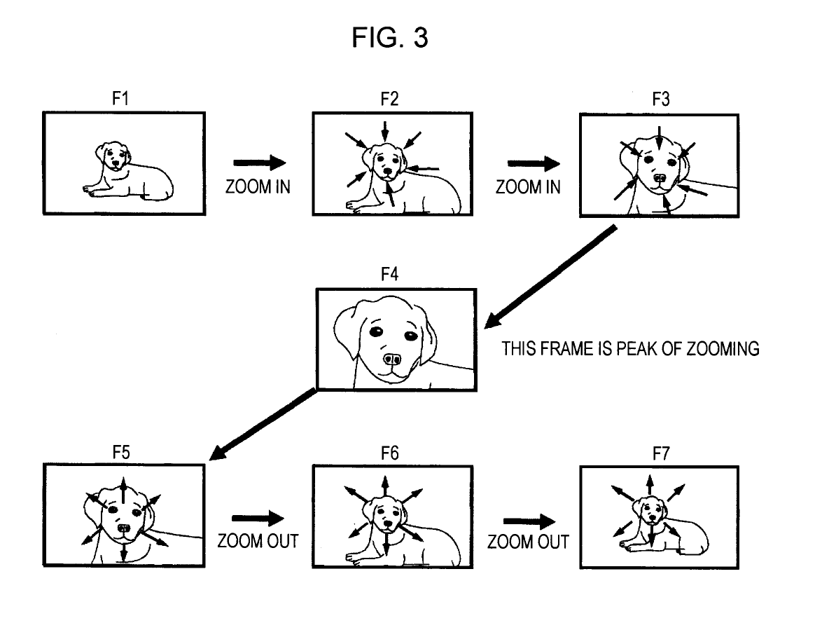

FIG. 4 is a view for explaining a peak of a scale parameter;

FIG. 5 is a flowchart for explaining digest reproduction image creation processing;

FIG. 6 is a flowchart for explaining a training image candidate creation processing; and

FIG. 7 is a block diagram illustrating a configuration example of a general purpose computer.

### DESCRIPTION OF THE PREFERRED EMBODIMENTS

Hereinafter, a preferred embodiment (hereinafter referred to as embodiment) of the present invention will be described in detail with reference to the drawings. The embodiment will be described in the following order.

1. First Embodiment

### 1. First Embodiment

### Configuration Example of Image Processing Apparatus

An image processing apparatus according to an embodiment of the present invention detects a scene that seems important from a moving image. Generally, in many cases of video taking operations, a subject observed by a person taking a video is zoomed in on, and thereafter zoomed out from in a moving image. Therefore, in this image processing apparatus, a frame in which the subject observed by the person taking the video is enlarged is detected as an important scene.

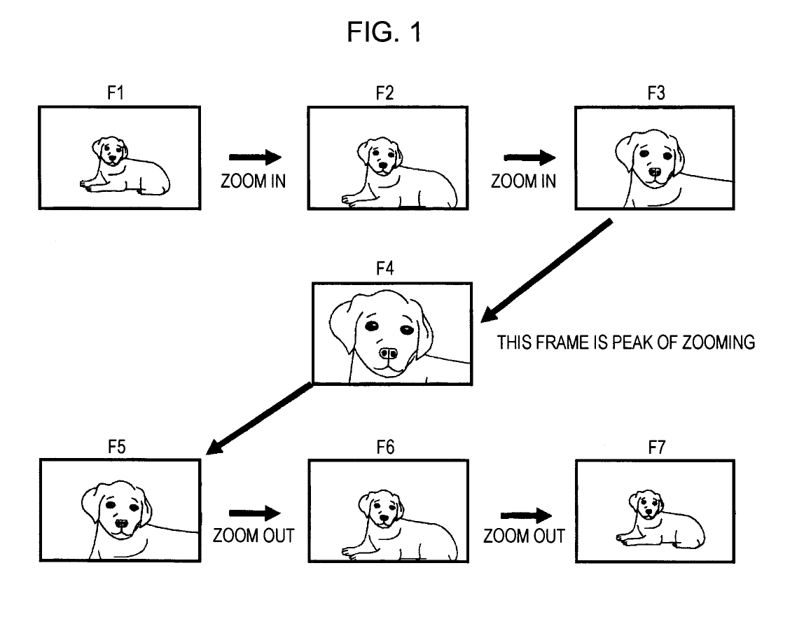

Specifically, when a subject (dog) is gradually zoomed in on, and thereafter zoomed out from as illustrated in a series of moving images in FIG. 1, the frame 4 which is most enlarged is detected as an important scene.

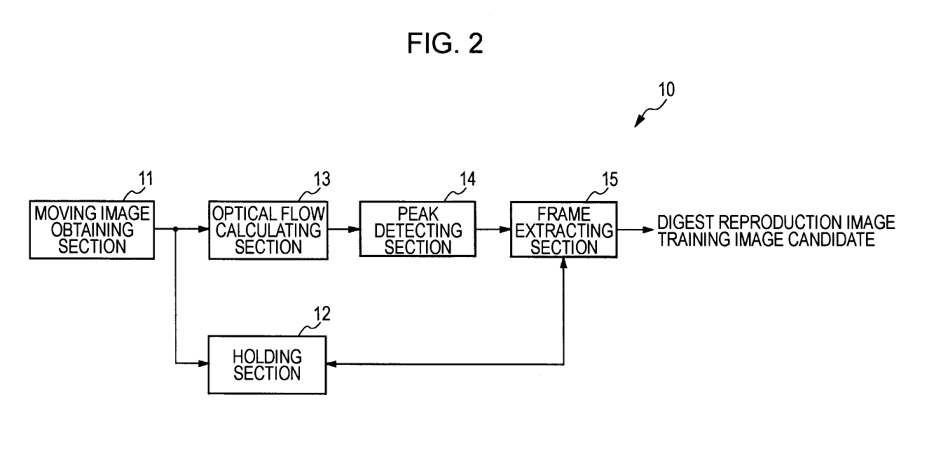

FIG. 2 is a block diagram illustrating a configuration example of the image processing apparatus according to the embodiment of the present invention.

This image processing apparatus 10 includes a moving image obtaining section 11, a holding section 12, an optical flow calculating section 13, a peak detecting section 14, and a frame extracting section 15.

The moving image obtaining section 11 obtains a moving image outputted from an external apparatus (for example, video camera, video recorder, and the like, which are not illustrated in the figures) connected to the image processing apparatus 10, and outputs the moving image to the holding section 12 and the optical flow detecting section 13.

The holding section 12 holds the moving image inputted from the moving image obtaining section 11, and provides a frame corresponding to a request from a next stage of frame extracting section 15 to the frame extracting section 15.

The optical flow calculating section 13 calculates an optical flow, calculates a scale parameter s indicating a change of zoom-in and zoom-out in the moving image from the calculated optical flow, and outputs the scale parameter s to the peak detecting section 14.

Here, the optical flow corresponds to how a pixel indicating the same point in the subject moves between the frames of the moving image, and specifically corresponds to a motion vector of the point on the subject.

To calculate the optical flow between the frames (to calculate the motion vector), it is widely known that a calculation formula of Lucas-Kanade optical flow, which is also called the gradient method shown by the formula (1) below, can be applied.

$$E = {\sum }_{x ∈ R} {[ F ( x + h ) - G ( x ) ]}^{2} ,$$

$$F ( x + h ) \approx F ( x ) + h \frac{\partial }{\partial x} F ( x ) ,$$

true when h is sufficiently small

$$\begin{matrix}o = \frac{\partial }{\partial h} E \\ \approx \frac{\partial }{\partial h} {\sum }_{x} {[ F ( x ) + h \frac{\partial F}{\partial x} - G ( x ) ]}^{2} \\ = {\sum }_{x} 2 \frac{\partial F}{\partial x} [ F ( x ) + h \frac{\partial F}{\partial x} - G ( x ) ] ,\end{matrix} \\ h \approx {[ {\sum }_{x} {( \frac{\partial F}{\partial x} )}^{T} [ G ( x ) - F ( x ) ] ] [ {\sum }_{x} {( \frac{\partial F}{\partial x} )}^{T} ( \frac{\partial F}{\partial x} ) ]}^{- 1} , \qquad ( 1 )$$

The calculation formula of Lucas-Kanade optical flow is a publicly known technique described in “An Iterative Image Registration Technique with an Application to Stereo Vision” Bruce D. Lucas & Takeo Kanade, 7th International Joint Conference on Artificial Intelligence (IJCAI), 1981, pp. 674-679. However, the optical flow can be calculated by using a formula other than the formula (1) described above.

For example, when calculating the optical flow from the moving image illustrated in FIG. 1, the direction of the optical flow is toward the center of the subject (dog) while zooming in, and the direction is away from the center of the subject (dog) to the outside while zooming out.

To calculate a zoom change (size) from the calculated optical flow, an affine transformation matrix (or projective transformation matrix) is obtained from a pair of points (x, y) and (x′, y′) corresponding to each other between frames by using the optical flow.

Generally, the affine matrix is represented by the following formula (2).

$$[ \begin{matrix}{x}^{′} \\ {y}^{′}\end{matrix} ] = [ \begin{matrix}a & b \\ c & d\end{matrix} ] [ \begin{matrix}x \\ y\end{matrix} ] + [ \begin{matrix}tx \\ ty\end{matrix} ] \qquad ( 2 )$$

When there is no rotational or translational component in the pair of points corresponding to each other between frames, and the points are only zoomed in on (or zoomed out from), the zoom change (size) appears as a scale parameter s as shown in the following formula (3).

$$[ \begin{matrix}{x}^{′} \\ {y}^{′}\end{matrix} ] = [ \begin{matrix}s & 0 \\ 0 & s\end{matrix} ] [ \begin{matrix}x \\ y\end{matrix} ] \qquad ( 3 )$$

This scale parameter s is outputted to the peak detecting section 14.

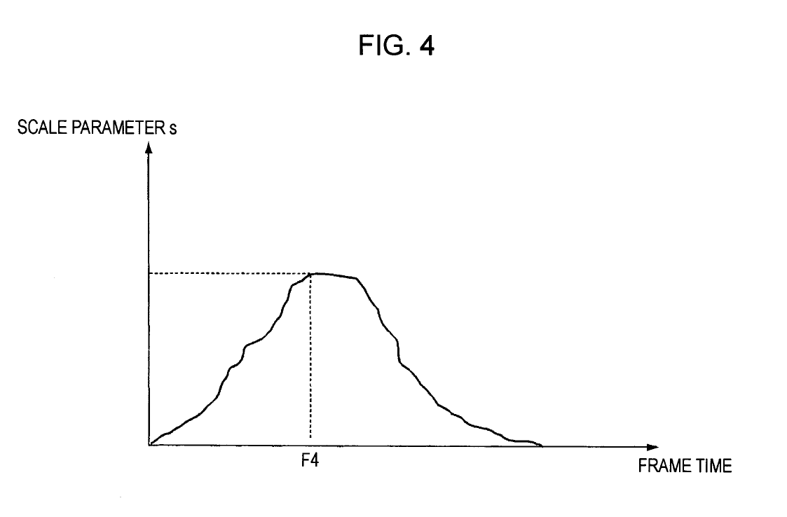

Return to FIG. 2. As illustrated in FIG. 4, the peak detecting section 14 detects an extreme value (hereinafter also referred to as zooming peak) of the scale parameter s inputted from the optical flow calculating section 14, and transmits the detection result to the frame extracting section 15.

The frame extracting section 15 obtains a frame corresponding to the extreme value of the scale parameter s from the holding section 12 on the basis of the detection result from the peak detecting section 14, and outputs the frame to the next stage.

### [Operation Explanation]

Next, operation of the image processing apparatus 10 will be described.

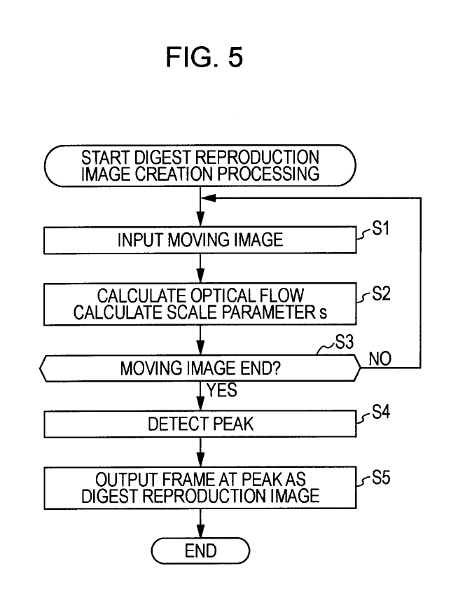

FIG. 5 is a flowchart explaining digest reproduction image creation processing corresponding to the inputted moving image by the image processing apparatus 10. In the digest reproduction image creation processing, a frame that seems important is outputted as a digest reproduction image from the frames constituting the moving image.

In step S1, the moving image obtaining section 11 obtains a moving image outputted from an external apparatus connected to the image processing apparatus 10, and provides the moving image to the holding section 12 and the optical flow detecting section 13. The holding section 12 holds the moving image inputted from the moving image obtaining section 11.

In step S2, the optical flow calculating section 13 calculates an optical flow of the moving image provided from the moving image obtaining section 11, calculates a scale parameter s from the calculated optical flow, and outputs the scale parameter s to the peak detecting section 14. The peak detecting section 14 holds the scale parameters s inputted sequentially.

In step S3, the moving image obtaining section 11 determines whether or not the input of the moving image from the external apparatus ends, and until the input of the moving image from the external apparatus ends, the moving image obtaining section 11 returns the process to step S1 and continues to provide the moving image to the holding section 12 and the optical flow detecting section 13.

In step S3, when the input of the moving image from the external device is determined to end, the process proceeds to step S4. In step S4, the peak detecting section 14 detects an extreme value of the scale parameter s inputted from the optical flow calculating section 13, and transmits the detection result to the frame extracting section 15.

In step S5, the frame extracting section 15 obtains a frame corresponding to the extreme value of the scale parameter s from the holding section 12 on the basis of the detection result from the peak detecting section 14, and outputs the frame as the digest reproduction image to the next stage. Then, the digest reproduction image creation processing ends.

According to the digest reproduction image creation processing as described above, a frame that seems important in which a subject observed by a person taking a video is enlarged can be outputted as the digest reproduction image.

Although, in the above described digest reproduction image creation processing, the entire moving image is held by the holding section 12, and the extreme value of the scale parameter s is detected from the entire moving image by the peak detection section 14, the moving image may be divided by a predetermined time unit to be processed. By doing so, the capacity of the holding section 12 can be reduced and processing of the peak detection section 14 can be lightened.

The frame that seems important which is extracted by the image processing apparatus 10 can be applied not only to the digest reproduction image, but also to a training image in object recognition.

Here, object recognition is a technique in which only a specific subject (for example, the face of a person) is detected from a moving image, and in object recognition of the related art, a training image has to be prepared by manually cutting out the specific subject to be recognized from the moving image.

On the other hand, when using the image processing apparatus 10 in processing for creating a training image for object recognition, a frame that seems important in which a subject observed by a person taking a video is enlarged can be used as the training image. When using not only the frame corresponding to the zooming peak, but also several frames before and after the frame as the training images, it is considered that the object recognition system can be developed to be an object recognition system having high robustness to image enlargement/reduction, parallel movement, rotation, and the like.

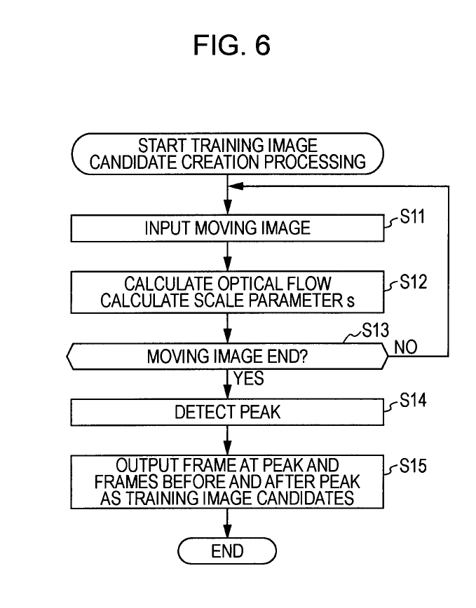

Next, FIG. 6 is a flowchart explaining processing for creating a training image for object recognition from an inputted moving image (hereinafter referred to as training image creation processing) by the image processing apparatus 10. In the training image creation processing, a frame that seems important and several frames before and after the frame are outputted as training image candidates from the frames constituting the moving image.

In step S11, the moving image obtaining section 11 obtains a moving image outputted from an external apparatus connected to the image processing apparatus 10, and provides the moving image to the holding section 12 and the optical flow detecting section 13. The holding section 12 holds the moving image inputted from the moving image obtaining section 11.

In step S12, the optical flow calculating section 13 calculates an optical flow of the moving image provided from the moving image obtaining section 11, calculates a scale parameter s from the calculated optical flow, and outputs the scale parameter s to the peak detecting section 14. The peak detecting section 14 holds the scale parameters s inputted sequentially.

In step S13, the moving image obtaining section 11 determines whether or not the input of the moving image from the external apparatus ends, and until the input of the moving image from the external apparatus ends, the moving image obtaining section 11 returns the process to step S11 and continues to provide the moving image to the holding section 12 and the optical flow detecting section 13.

In step S13, when the input of the moving image from the external device is determined to end, the process proceeds to step S14. In step S14, the peak detecting section 14 detects an extreme value of the scale parameter s inputted from the optical flow calculating section 13, and transmits the detection result to the frame extracting section 15.

In step S15, the frame extracting section 15 obtains a frame corresponding to the extreme value of the scale parameter s and a predetermined number of frames before and after the frame from the holding section 12 on the basis of the detection result from the peak detecting section 14, and outputs the obtained frames as training image candidates to the next stage. In the object recognition system located in the next stage, all the training image candidates may be used for learning, or the object recognition system may cause a user to select a training image used for learning from the training image candidates. Then, the training image creation processing ends.

According to the training image creation processing described above, a frame that seems important in which a subject observed by a person taking a video is enlarged, and several frames before and after the frame can be outputted as the training image candidates.

In the same way as the digest reproduction image creation processing, in the training image creation processing, the moving image may be divided into a predetermined units of time and processed. By doing so, the capacity of the holding section 12 can be reduced and the processing load of the peak detection section 14 can be reduced.

The series of processing operations described above can be implemented by hardware, and also implemented by software. When the series of processing operations is implemented by software, a computer in which a program constituting the software is installed in dedicated hardware is used, or the program constituting the software is installed in, for example, a general purpose personal computer which can perform various functions by installing various programs from a program recording medium.

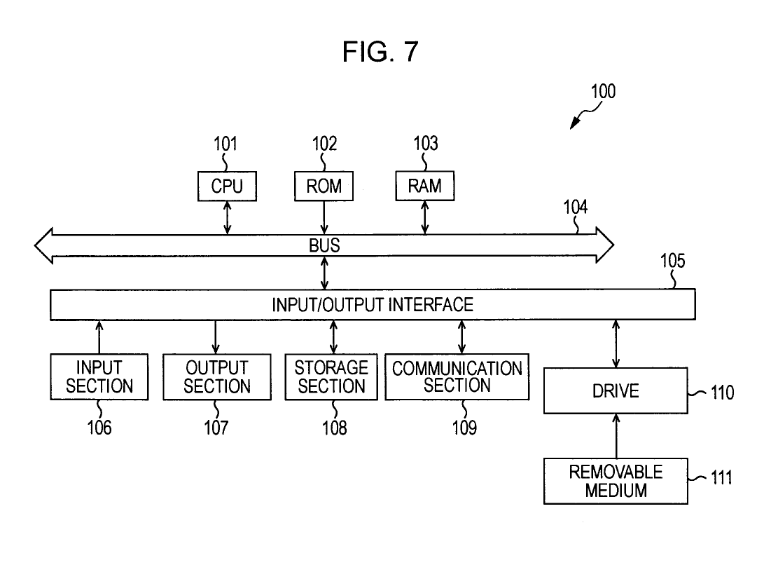

FIG. 7 is a block diagram illustrating a hardware configuration example of a computer which performs the series of processing operations described above by executing a program.

In this computer 100, a CPU (Central Processing Unit) 101, a ROM (Read Only Memory) 102, and a RAM (Random Access Memory) 103 are connected to one another by a bus 104.

An input/output interface 105 is further connected to the bus 104. An input section 106 including a keyboard, a mouse, a microphone, and the like, an output section 107 including a display, a speaker, and the like, a storage section 108 including a hard disk, a non-volatile memory, and the like, a communication section 109 including a network interface and the like, and a drive 110 for driving a magnetic disk, an optical disk, an optical magnetic disk, or a removable medium 111 such as a semiconductor memory are connected to the input/output interface 105.

In a computer having a configuration as described above, the CPU 101 loads a program stored in the storage section 108 into the RAM 103 via the input/output interface 105 and the bus 104, and executes the program, so that the series of processing operations described above is performed.

For example, the program executed by the computer (CPU 101) is provided by being recorded in a magnetic disk (including a flexible disk), an optical disk (CD-ROM (Compact Disc-Read Only Memory), DVD (Digital Versatile Disc), and the like), an optical magnetic disk, or a removable medium 111 that is a package medium including a semiconductor memory, or provided via a wired or wireless transmission medium such as a local area network, the Internet, and digital satellite broadcasting.

The program can be installed in the storage section 108 via the input/output interface 105 by mounting the removable medium 111 in the drive 110. Also, the program can be installed in the storage section 108 by receiving the program by the communication section 109 via a wired or wireless transmission medium. In addition, the program can be installed in the ROM 102 or the storage section 108 in advance.

In this description, the system represents an entire apparatus including a plurality of apparatuses.

The embodiment of the present invention is not limited to the embodiment described above, and various modifications may be made without departing from the scope of the present invention.

The present application contains subject matter related to that disclosed in Japanese Priority Patent Application JP 2009-073141 filed in the Japan Patent Office on Mar. 25, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
in the image processing apparatus which detects a representative frame of a moving image,
holding means configured to hold the moving image which is inputted;
detecting means configured to detect a peak of zooming that occurs in the inputted moving image; and
extracting means configured to extract the representative frame corresponding to the detected peak from a plurality of frames constituting the held moving image.

2. The image processing apparatus according to claim 1, further comprising:
calculating means configured to calculate an optical flow of the inputted moving image and calculate a scale parameter indicating a zoom state of each frame on the basis of the calculated optical flow,
wherein the detecting means detects an extreme value of the scale parameter as the peak of zooming that occurs in the inputted moving image.

3. The image processing apparatus according to claim 1 or 2, wherein the extracting means extracts the representative frame corresponding to the detected peak from a plurality of frames constituting the held moving image, and outputs the representative frame as a digest image.

4. The image processing apparatus according to claim 1 or 2, wherein the extracting means extracts the representative frame corresponding to the detected peak and a predetermined number of frames before and after the representative frame from a plurality of frames constituting the held moving image, and outputs the representative frame and the predetermined number of frames as training image candidates in object recognition.

5. An image processing method comprising the steps of:
in the image processing method which detects a representative frame of a moving image,
holding the moving image which is inputted;
detecting a peak of zooming that occurs in the inputted moving image; and
extracting the representative frame corresponding to the detected peak from a plurality of frames constituting the held moving image.

6. A program that is a control program of an image processing apparatus for detecting a representative frame of a moving image, the program causing a computer of an image processing apparatus to execute processing comprising the steps of:
holding the moving image which is inputted;
detecting a peak of zooming that occurs in the inputted moving image; and
extracting the representative frame corresponding to the detected peak from a plurality of frames constituting the held moving image.

7. An image processing apparatus comprising:
in the image processing apparatus which detects a representative frame of a moving image,
a holding section configured to hold the moving image which is inputted;
detecting section configured to detect a peak of zooming that occurs in the inputted moving image; and
extracting section configured to extract the representative frame corresponding to the detected peak from a plurality of frames constituting the held moving image.
